(19) United States
(12) Patent Application Publication
(10) Pub. No.: US 2002/0083059 A1
(43) Pub. Date: Jun. 27, 2002

(54) Workflow access control

(76) Inventors: Woodward Crim Hoffman, Hoboken, NJ (US); Sean Togher, Upper Saddle River, NJ (US)

Correspondence Address: HANDAL & MOROFSKY, 80 WASHINGTON STREET, NORWALK, CT, 06854, US

(21) Appl. No.: 09/997,407

(22) Filed: Nov. 29, 2001

Related U.S. Application Data
(60) Provisional application No. 60/250,047, filed on Nov. 30, 2000.

(51) Int. Cl. G06F 7/00

(52) U.S. Cl. 707/9

(57) ABSTRACT

A software database access control system for providing a flexible method of designating areas of access and functions within the areas of access within a database system for users comprising: a user profile possessed by an authorized user, the user profile comprising permitted areas of access within a database system, and the permitted areas of the database system being accessible when certain predetermined conditions are met by the user profile; a firewall around the database system such that the database is accessible if the user profile allows access; and a virtual user being a logical entity and having sole authorization to alter the database system at the direction of the authorized user. An embodiment of the present invention also having audit trail capabilities for the tracking of requested changes to the database system, or actual changes performed to the database system.

### CROSS REFERENCE TO RELATED APPLICATIONS

This application claims the benefit of pending U.S. provisional patent application No. 60/250,047 filed Nov. 30, 2000, the disclosure of which is hereby incorporated herein by reference thereto.

### TECHNICAL FIELD

The present invention relates to a novel method for controlling access to databases. More particularly, the present invention provides a flexible method for access to databases in which unconditional access can be given based on the user's role within a company, or conditional access can be given, based on other criteria that must be met before access is granted. In particular, and in accordance with the present invention, actual updates to the database are accomplished by a single user, a “virtual” user, who has the sole authority to update the. database according to the requests passed to it by the present invention.

### REFERENCE TO GOVERNMENT FUNDING

Not Applicable.

### BACKGROUND

Complex database systems are increasingly important in many aspects of daily life. Such databases contain growing amounts of private or trade secret information. Confidential information such as medical records, bank records, brokerage account records, legal documents, product plans, and prices, for instance are stored in or accessed through various types of databases. Such information should only be viewed and/or modified by appropriate people Because of rapid changes in personnel, and additions and changes in the applications those personnel are permitted to use, an ability is needed such that access permissions can be changed rapidly, and in an easy manner without the need of specialized knowledge. Accordingly, it would be helpful to make database security controls relatively easy to implement, and yet capable of providing the highest level of access control.

Existing control systems, such as systems that take a binary approach to function access controls, i.e., function access is either granted or not, but there is no implementation of granting of conditional rights such as those contemplated by the present invention. “Conditional rights” are when permission is granted only if the user has met predetermined condition(s). Existing control access systems also focus on limiting access from within the application processes, leaving the database open to external tampering by those who can access the database directly, because the application still requires full database table privileges for all users to complete database update tasks.

Databases use various approaches to control access to objects and attributes, including access control lists, inherited rights filters, and security equivalences. An access control list (“ACL”) is an optional property of every object class. In some implementations, every object in the database can have an ACL. Multiple ACLs may exist on a single object, and there is no limit (other than space and efficiency considerations) on the number of ACLs per object. The ACLs of a target object identify specific trustees, namely, objects that are given rights to access the target object and/or properties of the target object. In short, each ACL on a target object normally grants at least one access right to at least one trustee whose identity is specified in the ACL.

In some systems, rights granted to “object rights” or “all properties rights” may be inherited. For instance, rights granted at a container may also apply to all objects in the subtree of which the container is the root.

It is often desirable to grant rights suitable for administration of particular resources. For instance, a printer administrator would need rights to add, delete, and modify printer objects in a subtree. A telephone number administrator would need rights to modify telephone numbers or user objects. A password administrator would need rights to change a user's password when the user forgets the original password. And, a personnel administrator would need rights to create, modify, delete, and move user objects to reflect personnel changes. Most (or all) users need to be granted access to modify their own files, and change their own personal information, such as their telephone numbers and their addresses. It is desirable to grant these specialized administration rights in a way that is compatible with existing access control mechanisms, so that the database is not taken out of service during a long and painful conversion process.

One conventional approach is to give each of these specialized administrators supervisor rights to the appropriate subtree(s). Unfortunately, this often gives specialized administrators more rights than are strictly necessary. Furthermore it cannot be practically used when giving individual rights to users. Granting excess rights may lead at best to inconsistent attempts to change the database, as when a user changes a phone number and an administrator inadvertently loses the update by restoring data from an old backup. At worst, excess rights may lead to a security breach which compromises the secrecy and the integrity of information in the database.

Another approach is to place an appropriate ACL on each administered object. However, rather than easing administration, this creates significant maintenance burdens. The number of objects involved is often large, and updating the ACLs in a large subtree can be time-consuming, tedious, and error-prone.

Another approach, as is illustrated in Jarvis, U.S. Pat. No. 6,308,181 provides tools for controlling access to objects in a database. In one embodiment, a computer-implemented method begins by choosing at least one target object in the database and then choosing a positional relationship which will be interpreted in reference to the target object. In a hierarchical database possible positional relationships include “child”, “parent”, “grandchild”, and so on.

In contrast to prior art systems for sophisticated network access controls or other such systems, the present invention resides in the memory of a computer as an application external to any database whose access it controls. Also, objects whose access is controlled by the present invention do not require that trustees or any data attribute be attached to an object to be updated in the database being controlled. In accordance with the present invention, access control is granted or denied based on user-configurable conditions not related to the positions of objects or the hierarchy of objects in a database, and is completely independent of any of the data management functions specific to a database. By residing as a separate application external to the data base being updated, complete flexibility is enabled without the need to reconfigure database objects specific to computer applications.

### SUMMARY OF THE INVENTION

The inventive system achieves great simplicity of use, but with control levels configurable at an extremely granular level of system update access, and highly versatile and invasive control over database update capabilities.

### BRIEF DESCRIPTION OF THE DRAWINGS

The advantages, and the system and apparatus of the present invention will be understood from the following description taken together with the drawings, in which:

FIG. 1 is a schematic overview of an embodiment of the present invention;

FIG. 2 is a flowchart illustrating the creation and workings of tags for guard scripts in the present invention; and

FIG. 3 is a flowchart showing the operation of the embodiment of FIG. 1.

### DETAILED DESCRIPTION OF THE INVENTION

An access control system is described for creating and maintaining database processing access permissions based on a role-function-guard approach. The access control system is a software layer that resides between the primary application and its database to provide means of creating and maintaining dynamic links between users, their role(s), functions specified within those roles, and optional guard scripts to be evaluated when a user attempts to complete a database processing function. This system gives those in charge of database security a wide variety of database access allocations for data retrieval and update.

One way to achieve this level of control is to provide a flexible access system that can be configured to evaluate a user's permissions under specific circumstances. An example of this flexible access is a system that allows the monitoring of the state of a portfolio is described in U.S. Provisional Patent Application entitled “Accounting System for Dynamic State of the Portfolio Reporting” filed on Nov. 24, 2000, the disclosure of which is incorporated by reference. In this example, during the life cycle of a trade, only specific users are permitted to modify that trade's data.

The present inventive system provides a flexible set of rules to evaluate a user's permissions in any given situation for broader applications. To fill this need, the present invention comprises a unique system of roles, functions, and “guard” scripts to be evaluated whenever a user attempts to update the database. A further refinement of the present invention's capabilities employs the optional use of application data tags. The system works from any application process, whether that process is invoked from inside a graphical user interface or from the command line of a computer system. In addition, the inventive system creates a “virtual user.” This surrogate user is passed the update request only if the actual user's permissions, his/her roles, functions and, where appropriate, guard scripts, allow access to update the database. Creating a single virtual user with permission to update the database eliminates the need for maintaining detailed privileges for all the tables within the application, and ensures that absolutely no one but the virtual user can initiate database processing.

The virtual user functions between the application and the database it updates. The present invention creates a “firewall” such that only the virtual user can modify the data within the database. When an actual user requests access to database processing, the access control system evaluates the desired access against the functions and guards in the roles assigned to that actual user. Based on the outcome of the evaluation, the access control system passes or does not pass the database processing request to the virtual user for execution.

All of a user's roles and any user tag information are stored in a user's profile, which is invoked whenever that user enters an application session. Roles are used to specify which application functions can be accessed, including any guard conditions that must be evaluated before a function within that role can be accessed. Each role contains a list of the functions a user assigned that role can access. To save time but still achieve the granularity of control desired, administrators can create pre-configured roles that can be assigned to any number of users, and more than one role can be assigned to a single user. If a specific function is present in at least one of the roles assigned, the user can access that function. If a specific function is not included in any of the roles assigned to a user, the user cannot complete that function. If a user requires a function that is missing from the roles currently assigned to him, another role would have to be assigned to him that contains the required function, or the function would have to be added to one of the roles he already has assigned. In addition, a guard may be applied to a function such that conditions in the guard must be met before the function can be accessed. This gives a level of granularity. In still another mode of use of the present invention, a tag may be added to the user profile allowing access to the update function if conditions regarding the tag contents and the guard on the function, have been met. If changes are made to a user's profile while that user currently is logged into a session of the primary application, those changes would not come into effect until the user in question exits the application and then re-invokes their profile when they begin a new application session.

Because the current invention is so flexible in terms of allocating permission, there are many approaches to role creation. Schemes will depend upon an organization's culture and what a specific user needs to be able to do within a system function. Some organizations may create roles with access strictly limited by group. Each role might be named for the group to which it will apply, such as “Trading”, “Confirmations”, “Analytics”, etc., and users are simply assigned the role for their group. Supervisors could be assigned multiple roles to ensure that in an emergency situation, trades could be booked, modified, and confirmed within the same group, if necessary.

Every function in the primary application that involves database processing is published in a list maintained by the creators of that application. Functions can be inserted into roles, which are then assigned to users as appropriate. Access to a function is controlled only upon a database processing request. This means that a user with valid access to the application may be able to view or modify displayed data for analytic purposes in an application window or dialog box but would have no rights to save the changes unless those permissions existed in the role, or was otherwise assigned to that user.

Administrators can use a system of guard statements (“guards”) to further customize function access rights. Guards are a means to achieve the most granular level of access control. Each role-function pair can have a guard statement assigned that evaluates whether a user can complete a critical function. A guard is an optional statement that is attached to a database processing function. In the preferred embodiment, these guards are written in a public domain scripting language, for ease of use, however, other languages may be used with varying results. Whenever a user requests access to a function that exists in his role, any guard statement attached to that function is evaluated. The evaluation involves looking at the present state of the object in the database to be updated, and comparing that state with the proposed state of the object, that is, the state the object would be in after updating. The guard program then examines the two states, and evaluates the difference by comparing the conditions in the statement against the proposed state and then examines the user's profile to see if such a change is permitted for the user. The conditions of the guard statement must be met before the guarded function can be completed. For example, only if the statement returns “0”, indicating that the condition has been met, will the user be able to access a guarded function.

A particularly advantageous feature of the present invention is its ability to customize access to functions using a common computer application element relating to customized data. In a preferred embodiment of the invention, the system allows for customized information holders, which, for the purpose of this discussion, will be called “tags,” that can be attached to or associated with objects saved in the database. Tags are a means of enabling individual users to attach pieces of custom information to an object in an application to further define the characteristics or state of that object. Each tag has a user-specified tag name and a single value, which could be a selection from a set of user-specified choices or it could be a string of characters entered by the user. When an object is saved in an application, the tag and its value are saved with that object. Tags can be populated with information on a voluntary basis or on a required basis. For example, an organization might create a required tag attached to a transaction update interface to capture the name of the supervisor who gave the user the approval to complete a transaction entry. Another organization may create a tag attached to a user's profile to designate that employee's department. Another tag would be populated by the administrator who set up the user's profile.

While tags are not required for the present invention, they are an optional means of maximizing the granularity of access control. Applications that employ tags can use the present invention to control access at the most granular level. That is, a guard script can be written to evaluate a user's permission based upon the current contents of a tag. If a specific function is included in a user's role, but a tag associated with the user's profile or with the object to be updated in the database currently lacks the proper value required, as evaluated by a guard script, to allow access that function, the user will not be able to complete the function, even though that function is generally within their profile. If the value in that tag is changed such that the tag value would allow the user to pass the guard evaluation, the update would be permitted. For example, a tag named “TRANSACTION_INITIATED_BY” could be attached to an application object that saves the terms of a transaction, and that tag has a list of possible selections containing the last names of sales associates. A user's role could contain a transaction update function with a guard that limits that user's ability to update a transaction unless the tag TRANSACTION_INITIATED_BY, which is attached to the transaction, contains a specific sales associate's last name. If the transaction to be updated has no value for the TRANSACTION_INITIATED_BY tag or if the value is not the one specified in the guard script, the guard would evaluate the tag contents and deny the user access to update that specific transaction. If, however, the TRANSACTION_INITIATED_BY tag attached to the transaction contained the proper sales associate's name, the guard would evaluate the tag contents and permit the user to update the transaction.

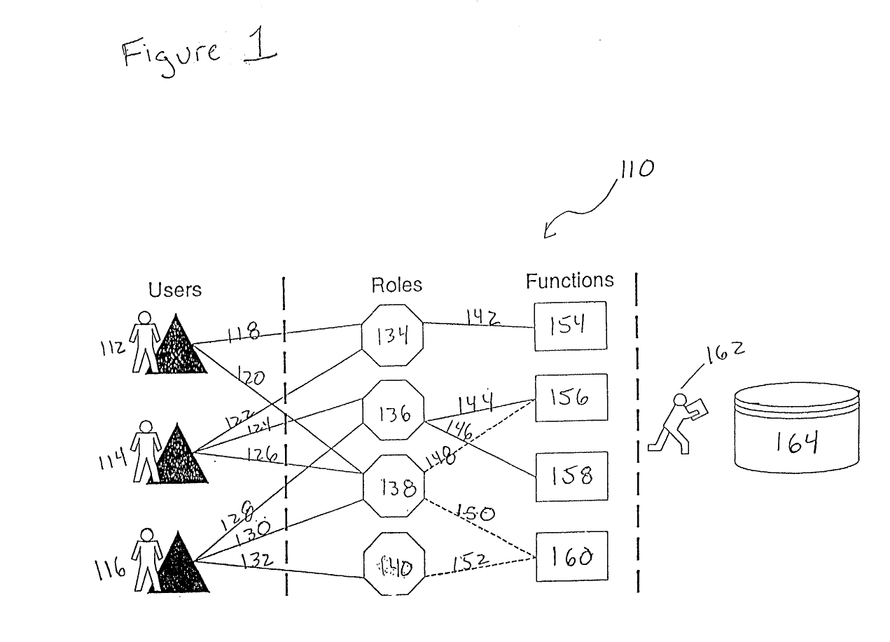

FIG. 1 illustrates a schematic overview of access control system 110. In this illustration there are three users 112, 114, and 116. Each user 112, 114, and 116 has a role or roles 134, 136, 138, and/or 140 assigned to him or her by the system administrator. Connections 118, 120, 122, 124, 126, 128, 130 and 132 of users 112, 114, and 116 to role 134, 136, 138 and 140 are illustrated by solid lines. Each of roles 134, 136, 138, and 140 is associated with function or functions 154, 156, 158, and/or 160 that they need to performed on database 164. Direct connections 142, 144, and 146 of roles 134 and 136 with functions 154, 156, and 158 are illustrated by solid lines. Conditional connections 148, 150, and 152 of roles 138 and 140 which have guard scripts attached 138 and 140, and functions 156, 158, and 140 are illustrated by dotted lines.

In system 110, only virtual user 162 can affect database 164. For example, user 112 wants to perform function 154. User 112's roles are 134 as illustrated by line 118, and role 138 as illustrated by line 120. Role 134's function is 154 as illustrated by solid line 142. Therefore, user 112 has permission from the workflow access control system to “instruct” the virtual user 162 to perform function 154 on the database 164.

In another example, user 114 wants to perform function 160. User 114's roles are 134 as illustrated by line 122, role 136 as illustrated by line 124, and role 138 as illustrated by line 126. Of these, only role 138 has the function 160, however, line 150 has a guard script attached, as illustrated by the dotted nature of the line, so for user 114 to get permission from the workflow access control system to “tell” virtual user 162 to perform function 160 on database 164, there are other criteria, beside his role 138 that must be met. For example, function 160 maybe to change a client's address. Guard script of line 150 may require that the user 114 be assigned as the service representative to the client whose address in being updated.

In yet another example, user 116 wants to perform function 154. User 116's roles are 136 as illustrated by line 128, role 138 as illustrated by line 130, and role 140 as illustrated by line 132. None of these roles 136, 138 or 140 have function 154, therefore user 116 will not have permission from the workflow access control system to “tell” the virtual user 162 to perform function 154 on the database 164.

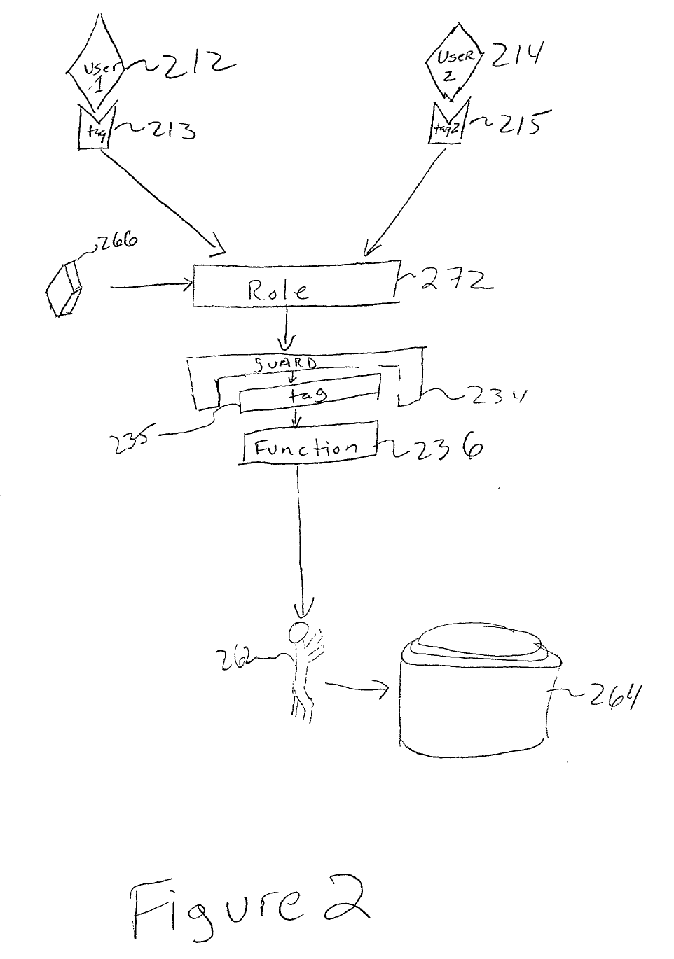

FIG. 2 further illustrates a highly granular level of access control available in the present invention. There are two sets of tags involved: one tag 235 attached to all trade transactions 236 in a database, and tag 213 and 215 attached respectively to user profiles 212 and 214, which contain roles with functions that may or may not be guarded. The organization used in this example has a policy regarding the trade tag 235 called “STATUS,” which is associated with all trade transactions saved to the database, such that only members of the Amendments group, such as user 212, can update the STATUS tag to “Amended”, and only members of the Confirmations group, such as user 214, can update the STATUS tag to “Confirmed”. Tag 213 indicates that user 212 is part of the amendments group, and tag 215 indicates that user 214 is part of the confirmation group. For the purposes of this discussion, a trade tag is a tag associated with a trade transaction that is saved in the database. In FIG. 2, the system administrator 266 creates a role 272 associated with the “update trade tag” function 236, which has a guard 234 attached to it. That guard 234 contains conditions, such as belonging to a certain group, that must be met before users assigned that role 272 can perform the “update trade tag” function 236, through the virtual user. When a user attempts to update a trade tag in the application, the guard evaluates the contents of a tag called USER_GROUP, which is a tag attached to all user profiles indicating to which group of employees the user belongs. After the user group is determined, the guard script then examines the value of the trade tag STATUS, which the user is attempting to update. Value choices for this tag include “Amended” and “Confirmed”. Based on the outcome of the guard's evaluation of which user group is allowed to enter which trade tag selection, access will be granted or denied.

When user 212, from the Amendments group, attempts to update the contents of a trade tag STATUS by selecting the option “Amended”, the present invention examines that user's role 272 and finds that the function “update trade tag” 236 has a guard 234 stating that only users from the Amendments group can update a trade tag with the “Amended” selection. The present invention evaluates guard script 234, and then compares the contents of the trade tag STATUS, which the user is attempting to update, with the contents of the user tag attached to the user's role. The guard script 234 finds that user 212 is in the Amendments group and therefore has permission to update the tag STATUS with the selection “Amended”, and so the update of the trade transaction in the database system 264 is permitted to be carried out by the virtual user 262. When user 214, from the Confirmations group, mistakenly attempts to update the same trade tag with the choice “Amended”, the guard script compares the user tag contents with the trade tag contents, finds that user 214 is in the Confirmations group and therefore does not have permission to update the tag with that selection, and so the update is denied.

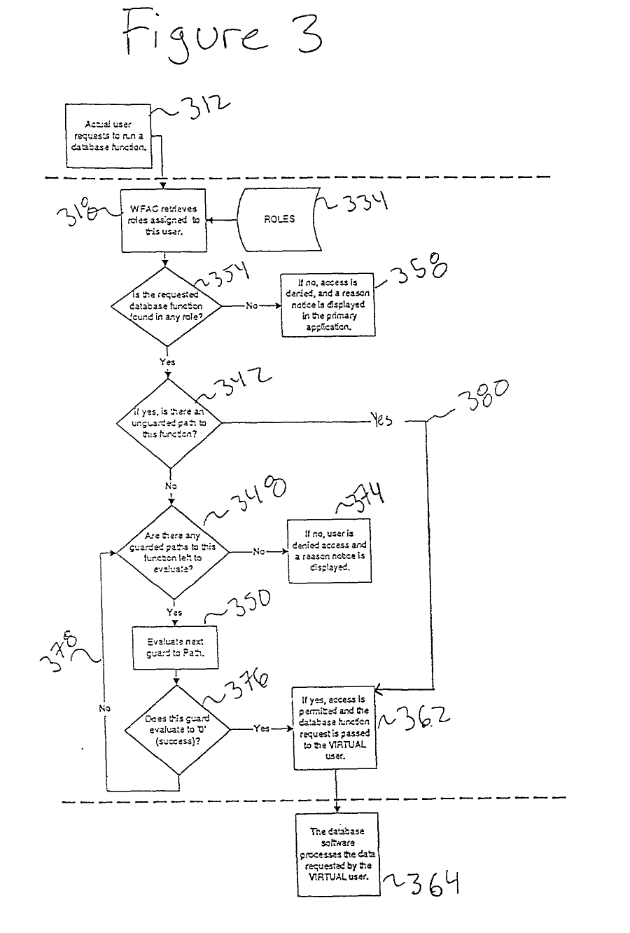

FIG. 3 illustrates a flowchart of the workflow access control system 310. At step 312 the user requests a function of the database. At step 318 system 310 retrieves roles 334 of the user making the request. At step 354 system 310 then compares the roles assigned to that user, and the functions contained within those roles with the function requested. If the function is not one assigned to the role of that user, then at step 358 system 310 does not allow the user's request to reach the virtual user for execution, access is denied.

If the function is found in any of the user's role at step 354, then at step 342 system 310 checks for any unguarded paths to the requested functions. If there is an unguarded path at step 342, then access is permitted and the request follows path 380 to the virtual user for execution at step 362, where the database processes the data at step 364.

If there is no unguarded path at step 342, then at step 348 the system 310 checks if there is a guarded path assigned to the user for the requested function left to evaluate. If there are no guarded paths left to evaluate, then at step 374 the system 310 does not allow the user's request to reach the virtual user, access is denied.

If there is a guarded path at step 348, then that guard is evaluated at step 350. If that guard evaluates to “0” at step 376, meaning that the conditions are met, then the request goes to the virtual user for execution at step 362 where the database processes the data at step 364.

If the conditions are not met at step 376, then the requested function follows path 378 back to step 348 to check for another guarded path, and then the requested function follows the flow as listed above until all unguarded paths are exhausted, then at step 374 the system 310 does not allow the user's request to reach the virtual user. In the alternative if a guarded path evaluates to “0”, or true. then the request goes to the virtual user for execution at step 362 where the database processes the data at step 364.

While illustrative embodiments of the invention has been described, it is, of course, understood that various modifications of the invention will be obvious to those of ordinary skill in the art. Such modifications are within the spirit and scope of the invention which is limited and defined by the appended claims.

1. A software database access control system comprising:
a) a plurality of user profiles, each of said user profiles comprising information relating to a condition or conditions which have to be met in order for certain areas of said database system to be accessible;
b) a firewall around said database such that the database system is accessible if said user profile allows access; and
c) a virtual user being a logical entity with sole authorization to alter said database system at the direction of a user whose user profile allows modification to said database system.

2. A software database access control system as claimed in claim 1 wherein for a user employed by a proprietor of the database system said predetermined conditions include characteristics of the user's job function.

3. A software database access control system as claimed in claim 2 wherein said characteristics are set by an entity, said entity being an organization, company or firm utilizing and controlling said system.

4. A software database access control system as claimed in claim 2 wherein said characteristics are unique to an individual user.

5. A software database access control system as claimed in claim 2 wherein said characteristics are unique to category of user and shared by more than one individual.

6. A software database access control system as claimed in claim 2 wherein said proprietor is an owner, lessee, or other entity controlling the database system.

7. A software database access control system as claimed in claim 1 wherein said predetermined conditions are based on a user's characteristics of user's application of database.

8. A software database access control system as claimed in claim 1 wherein said predetermined conditions are based on a user's characteristics of a user's project requiring database access.

9. A software database access control system as claimed in claim 1 wherein said user is a person or organization.

10. A software database access control system as claimed in claim 1 wherein said user is a program, said program acting on behalf of a person or organization.

11. A software database access control system as claimed in claim 1 wherein said user is an employee, vendor, contractor, customer, or government agency.

12. A software database access control system as claimed in claim 1 wherein said database system is comprised of one database.

13. A software database access control system as claimed in claim 1 wherein said database system is comprised of a plurality of databases located at a single location.

14. A software database access control system as claimed in claim 1 wherein said database system is comprised of a plurality of databases located at a plurality of locations.

15. A software database access control system as claimed in claim 1 further comprising an audit trail, said audit trail comprising a record of requests made to the virtual user for changes to the database system.

16. A software database access control system as claimed in claim 16 wherein said record of requests comprising a record of the user requesting the change, the type of change requested, the date and time the change requested, the database said change was requested for and if the change was executed by the virtual user.

18. A software database access control system as claimed in claim 1 further comprising an audit trail, said audit trail comprising a record of changes made to the database system.

19. A software database access control system as claimed in claim 18 wherein said record of requests comprising a record of: the user requesting the change, the type of change made, the date and time the change was executed, and the database changed.

20. A software database access control system as claimed in claim 1 further comprising:
d) at least one additional condition connected to said firewall; and
e) at least one additional characteristic connected with at least one of said user profiles;
wherein said additional condition must be satisfied by said additional characteristic prior to access or modification of said database system being accomplished.

21. A software database access control system as claimed in claim 20 wherein said additional characteristic is a user's personal identity, department, division or company.

22. A software database access control system to control access to a database system for a plurality of users comprising:
a) a plurality of user profiles connected respectively with the plurality of users;
b) a plurality of roles, said roles being connected with one or more of the user profiles;
c) a plurality of functions said functions being connected with one or more of the roles;
wherein a user cannot perform a given function on or to the database system unless the user has access to the function by having its user profile being connected with a role which is connected with the function.

23. The system according to claim 22 wherein some of the connections between the roles and the functions they contain are conditional.

24. A software database access control system to control access to a database system for a plurality of users comprising:
a) a plurality of user profiles connected respectively with the plurality of users;
b) a plurality of roles, said roles being connected with one or more of the user profiles;
c) a plurality of functions said functions being connected with one or more of the roles;
d) a virtual user being a logical entity with sole authorization to access or alter said database
wherein said virtual user will only perform a specific function if the user requesting such a function is connected to a role which is connected to the function.
